(19) United States
(12) Patent Application Publication
(10) Pub. No.: US 2012/0102659 A1
(43) Pub. Date: May 3, 2012

(54) Distance And Incline Measuring Tools

(75) Inventor: John Paul Ingham, Somerset, CA (US)

(73) Assignee: John Paul Ingham, Somerset, CA (US)

(21) Appl. No.: 12/916,488

(22) Filed: Oct. 30, 2010

(51) Int. Cl. B25F 1/00; G01C 9/00; G06F 15/00; A01B 1/02

(52) U.S. Cl. 7/116; 294/57; 702/154; 7/164

(57) ABSTRACT

A tool useful for measuring the shortest distance from a point in space to an imaginary line having any inclination and in the same vertical plane as the point. An embodiment requires a form of contact with only a single point on the line, uses an inclinometer, may use a length measuring system, and performs a trigonometric calculation to report data related to the shortest distance. Variants include integration of an inclinometer with a form of length measurement device. One embodiment integrates a manually powered excavation, fill and/or grading implement such as a shovel with an inclinometer attached to or imbedded in the shovel handle. Trigonometric functions of incline angles and length measurements report data related to the shortest distance in general, and in particular to ongoing depth of manual excavations, cuts or fills relative to a desired slope or grade.

### FIELD

Embodiments relate generally to a tool to estimate or measure the shortest distance from a point of the environment to an imaginary, sloped reference line in space. A field of application includes reducing the time, cost and physical effort used in measuring the depth of an excavation, cut or fill relative to a reference grade by integration of a depth measurement tool with an implement, tool or object used at the excavation site.

### BACKGROUND

A manual grading operation includes manually digging or excavating a defined construction area to a predetermined depth from a prescribed slope or percent grade relative to a finish grade such as existing concrete or the top of a form.

The problem of characterizing the rough grade depth from a reference slope or percent grade is solved conventionally by alternately digging a grade to an approximate depth with one set of tools and then measuring the grade depth with a different set of tools. A conventional measurement of depth from a non-sloping grade uses a level with one surface of the level placed at the finish grade. With the laborer maintaining the level horizontal, the laborer then uses a tape measure or ruler to measure the depth of the rough grade from another point of the level. This solution requires providing a separate tool having a straight surface, a tool to measure the inclination, a tool to measure the depth from the straight surface, a tool to excavate or fill, and also requires carrying separate tools to the site and constantly exchanging tools during the excavation.

These tools and conventional process cannot be conveniently used to manually prepare sloping grades such as ramps or sewer lines with a prescribed slope.

References show that bubble levels have been incorporated into the body of manually operated tools such as a smoothing trowel or a landscaping rake. References show that the depth of the work is not measured using inclinometer data, nor is any method to do so indicated or suggested. References show length measuring systems in combination with inclinometers, but none show a triangulation system appropriate for conveniently measuring depth to a specified, imaginary reference line in space. References show many powered excavation tools with angle and depth determination systems that control excavation, but not tools or methods applicable or appropriate for manual excavation measurement. References show tools using inclinometers, but not depth measurements using trigonometric functions of inclinometer data. Compound tool, excavating implements and rulers are commercially available, but none incorporate a grade depth measuring feature, nor do any render the handle or body of an object to function as a grade or excavation depth measuring tool.

### SUMMARY

A tool to measure the depth of a point of an excavation relative to a desired percent grade uses trigonometric calculations and measurements based largely on inclinometer angle data. An excavation “grading tool” also capable of estimating excavation depth relative to a reference line bypasses the extra effort and time associated with repeated tool changes. Integrating an inclinometer-based length measurement tool with an object, such as an implement or object associated with manual construction, provides an embodiment with novel utility. Triangulation to an imaginary reference line using an inclinometer provides a novel way to measure distance, contrasting direct measurements.

More generally, a tool is configured to measure or estimate distance from a point in space to a desired, inclined, imaginary reference line in the same vertical plane as the line, e.g. directly above or below it. The tool combines tool inclination angle with data associated with a “form of contact” of the tool with the excavation. The imaginary line is analogous to a tight string often used as a guide in construction sites. This tool does not need the physical line.

Trigonometric calculations combine available data, such as an inclination measurement of the object or implement, the inclination of the desired slope, and vectors defined by the various points of the reference and object. The result is a measurement or estimate of the desired distance, such as an excavation depth.

In each case, the only physical contact or access to the imaginary line is to a single reference point on the line, typically at the boundary of an excavation. The calculation is typically a vector cross product.

One convenient way to represent the desired distance is a ratio “distance per vector length.” The desired distance can then be quickly estimated by multiplying a vector length on the object by the ratio. When the absolute vector length is known or measured, then the desired distance can be calculated precisely. The object can often be a shovel or a piece of wood (i.e. 2×4). A length measuring device, the inclinometer and its calculation mechanism can be dynamically attached to an object. The “distance per vector length” then permits the length measuring device with inclinometer to be independent from the construction site objects and can still be dynamically integrated with them.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the teachings herein.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present teachings.

FIG. 1 describes an object used to measure excavation depth to a level grade, using a low precision inclinometer integrated with an implement found on an excavation site.

FIG. 2 describes an object used to measure excavation depth to a reference line, or sloped grade, using an inclinometer integrated with an implement found on an excavation site.

FIG. 3 describes an object used to measure an excavation depth relative to a reference line where the measurement does not require a separate ruler or length measuring system, and where the object includes an excavation tool.

FIG. 3-A sketches an embodiment where a length measuring system integrated with an inclinometer and a trigonometric transformation capability can measure the shortest distance from a point in space to an imaginary line in the same vertical plane as the point, given a form of contact with a single point of the line.

FIG. 4 describes the top view cross section of an object with an inclinometer display scale and trigonometric transformation display scale, embedded in a straight segment of the object.

FIG. 5 describes the side view cross section of an object with an inclinometer display scale and trigonometric transformation display scale integrated with an implement.

FIG. 6-A shows a 360 degree inclinometer display scale depicted as a bubble and ball in a circular tube, with angular markings.

FIG. 6-B shows a 360 degree inclinometer with the scale zero rotated to accommodate misalignments.

FIG. 7-A shows an analog display scale of a trigonometric depth calculation in units of “depth per vector length” exemplifying “tenths of an inch per vector foot”.

FIG. 7-B shows the trigonometric transformation depth calculation indicator juxtaposed with the inclinometer.

FIG. 7-C shows a trigonometric transformation depth indicator set for about 12 degrees of incline.

FIG. 8-A notionally shows a depth measuring tool integrated with an object or implement.

FIG. 8-B shows a depth measuring tool integrated with an object and rotated as it would be in a working configuration.

FIG. 8-C. shows a depth measuring tool integrated with an object in a working configuration, with the inclinometer package placed on a convenient part of the object.

FIG. 9 describes a distance measuring system using and inclinometer and trigonometric transformation for measuring the elevation difference between two different points of the environment.

FIG. 10 describes an object with an integrated length measuring system permitting measurement of distance from an excavation point to a desired slope, where the object is held at an arbitrary, convenient angle.

### DETAILED DESCRIPTION

A particular embodiment shows methods, devices and systems for integrating manually powered, excavation site tools with tools including an inclinometer, to measure distance from an excavation to a desired reference line. A more general embodiment integrates objects in general with tools including an inclinometer to estimate the shortest distance from a point in space to the reference line. “Excavation” in this document refers to a point in space and is used this way only to create a visual concept. For example, the higher of two concrete steps of a walkway is the “reference” and the lower step referred to as the “excavation”. An excavation can also refer to a “fill” or a “cut”.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

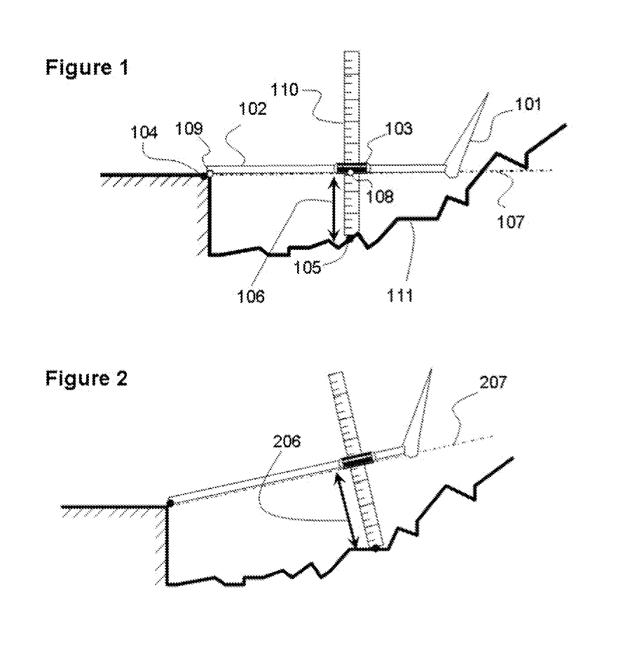

One embodiment integrates an excavation tool with an excavation depth measuring tool. FIG. 1 shows an excavating implement 101 including its handle 102 integrated with a simple inclinometer 103, a bubble level. “Handle” is used generically to generate a visual concept for an object that includes a relatively straight part 102 that is able to contact a reference point 104. The “handle” can represent various tools, implements and objects found at an excavation site. The inclinometer 108 can be integrated with a length measuring system or device 110 which contacts a point in space 105 of a fill, cut or excavation 111. The length measuring system 110 is referred to as a “ruler” to create a visual concept.

An inclinometer-ruler tool can be dynamically integrated with the handle or object when a user holds them together. “Integration” can take on many forms, such as being associated with, embedded in, attached to, dynamically attached to, contacting, or juxtaposed to another tool, for example, to an inclinometer, a trigonometric transformation system, a length measuring system, or to an object. Physical guides (not shown) on an inclinometer-ruler tool or on a handle can assure good relative alignment.

Some examples of implements and objects include a pick, pick-axe, rake, hoe, mattock, pry bar, shovel, scoop, or any length of a relatively straight piece of wood, metal, fiberglass or plastic pipe. More generally, the term object includes irregularly shaped objects, such as a hammer, with accessible segments that can at least be placed in contact with a reference point on the imaginary reference line or, separately, in a form of contact with a point in space directly above or below the reference line. A point on an excavation, cut, fill or elevation is a point in space.

In the simplest example, the user places a reference point 109 of the handle on the reference point 104, which is also on the imaginary reference line 107. This reference point 104 is often referred to as the “finish grade” 104. The user maintains the handle 102 to a horizontal 107, using the integrated inclinometer 103. A length measuring system (tape measure or ruler) 110 associated with the inclinometer 103 measures the depth 106 of the grade or excavation 105 from a point on a relatively straight portion of the shovel handle 108 to the excavation point 105 of the excavation 111.

The length measuring system, e.g. a ruler 110, provides a “form of contact”, where a ruler measures the distance 106 from the ruler point 108 to the excavation 105, by contacting both points 105,108. In general, the measurement can be physical, using a physical ruler, or non-physical, such as by one of many means, including touch-less contact means, such as laser, acoustic, IR and RF rulers.

The object reference point 109 and object ruler point 108 define an object vector. For example, the object vector starts at a point on a shovel handle 109 touching the reference point 104 on the reference line 107 and ends at another point on the handle 108.

Calculations use simple vectors and involve object inclination angle data. A unit vector along the reference line 107 defines the direction of the line. A point on the object referred to as a “ruler point” 108 is placed into a form of contact, i.e. using a ruler, with a point of the excavation 105. The reference point 104 and excavation point 105 define an environment vector, also referred to as an excavation vector for visual clarity. For example, the excavation vector starts at the reference 104 and ends at a point in space 105 on the excavation 111.

A requirement for computational ease is that the set of reference points and ruler points on the object lie on a relatively straight line. Here, “relatively” is determined by the user's error tolerance. Deviation from straight causes an error in depth if the deviation is not included in the trigonometric calculation. The allowable depth error required by the user therefore implies the degree of straightness, or the degree of computational and measurement complexity.

Embodiments may optionally include a straight segment or handle with flat parts at intended or probable reference or ruler points along the handle, or mechanical alignment parts to facilitate alignment of other tools such as tape measures, rulers, laser rulers, and inclinometers. The straight segments or handle may include other surfaces, markings or features used to estimate lengths, or to measure, extend or transfer the resulting measurements or grade depth measurements. Some of these markings obviously qualify as “length measurement systems”.

Field tests using the simplest, bubble-in-a-shovel-handle embodiment, have shown reduction of labor costs on the order of 10%. Integrating the separate functions of digging or excavation with measuring and displaying a grade depth into one or two tools reduces the number of tools carried to the site, maintained at the site and frequently and alternately exchanged by the user at the site.

Another, similar embodiment uses an inclinometer capable of measuring inclination such as incline percent grade or slope angle. As shown in FIG. 2, the user maintains the handle along the desired reference line 207 and measures the distance 206 to the excavation, similar to the procedure of the embodiment of FIG. 1. When the user holds the object such that the inclination of the object vector also has the desired inclination, then the ruler measurement is also a desired measurement of the excavation depth 206. This is one example of a labor-saving use by reason of the integrated inclinometer-ruler combination.

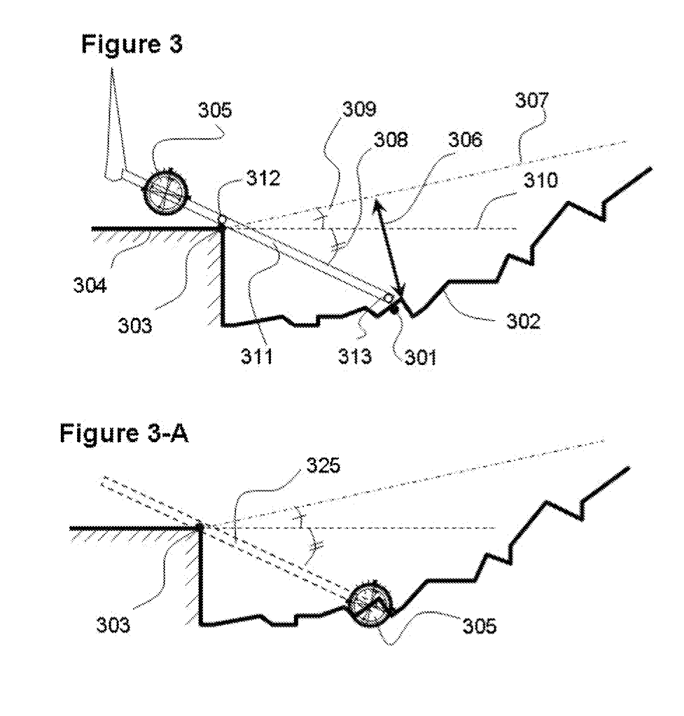

FIG. 3 shows an embodiment of a tool that permits sufficiently accurate estimation of distance 306, e.g. the excavation depth 306, to a desired grade 307 by triangulation and without needing to physically measure the depth. The embodiment includes an inclinometer 305 coupled to or integrated with a display system and integrated with an object or implement 311. The user indicates the desired slope 307 to the inclinometer system 305 as operational data. The user places a specific, prescribed reference point 312 of the implement handle 311 on the reference point 303 of the finish grade 304, and another specific ruler point 313 of the implement 311, such as the end of the handle 313, on the excavation point 301.

FIG. 3 shows how the “form of contact” by a ruler point 313 can also be direct and physical, where the ruler point 313 itself physically touches the excavation point 301.

The two points 312, 313 define an object vector, or handle vector, which is a vector along the object or tool handle. When an inclinometer is attached to a tape measure, a user can measure the length of the object vector 312, 313 directly, using a length measuring system, e.g. a ruler, and also read the excavation depth 306 result of the calculation on a trigonometric transformation display of the inclinometer 305.

The depth 306 relative to a desired slope 307 is the vector cross product of the object vector 312, 313 with a unit vector along the imaginary reference line 107. The vector cross product giving excavation depth is the trigonometric transformation:

depth=(length of object vector 312, 313)*sine (desired slope inclination 309+object inclination 308)

A display interface can accurately indicate the depth because a ruler can measure the object vector length. The vector length is the distance between the specific reference point 312 and the specific ruler point 313 on the object or implement 311. The display can include many modes, such as auditory beeps, spoken words, visual displays, or wireless transmissions. The user supplies operational data such as the desired inclination or slope data. For example, the display can also “beep” when the object vector is maintained at the desired slope.

The inclinometer interface 305 communicates excavation depth data to the user. Depth related information includes, for example, excavation depth, depth per length of handle vector, depth yet to be excavated, and handle inclination. These can be reported in units or formats useful to the user.

FIG. 3 also depicts an embodiment where the user may contact the reference and/or excavation points at arbitrary points along the object or handle. The user touches two points on the handle to the environment, one on the reference and one on the excavation. For example, a laborer places one convenient reference point 312 of a tool 311 on the reference 303, and a convenient ruler point 313 of the tool 311 on the point of interest 301, e.g. the excavation surface. This permits the laborer to estimate the depth even though the absolute vector length is not known, with or without a ruler. The mechanical or electronic inclinometer 305 is configured to display the depth 306 in terms of “depth per vector length”.

Since construction site users are known to be adept at estimating distance between two points, they multiply their estimate of the distance between object reference and ruler point by the indicated “depth per vector length”. Their calculation results in a useful estimate of the depth.

A key element permitting a laborer to conveniently estimate distance or depth in the above category of embodiment is to choose the units or “depth per vector length” to make multiplying simple, fast and easy. For example, the display system can indicate “NNN tenths of an inch per foot”, or “millimeters per meter”. The value “NNN” is calculated and displayed or transmitted to the user. This feature of the embodiment permits measuring the depth in situations where the length is far less than the length of the excavation implement handle or in another case where the depth is almost as deep as the implement 111 is long. In general, the “depth per vector length” distance data can be reported as a unit of length of the desired distance per a unit of length of the vector.

FIG. 3-A sketches an embodiment where a length measuring system integrated with an inclinometer and a trigonometric transformation capability 305 can measure the shortest distance from a point in space to an imaginary line in the same vertical plane as the point, given a form of contact with a single point of the line 303. The form of contact with a single point of the line 303 is performed by the length measuring system 305 and its associated “ruler” 325. For example, this form of contact can physical, using a physical ruler or tape measure 305. As another example, this form of contact can touchless, using a laser or acoustic length measuring system 305 and its “beam ruler” 325.

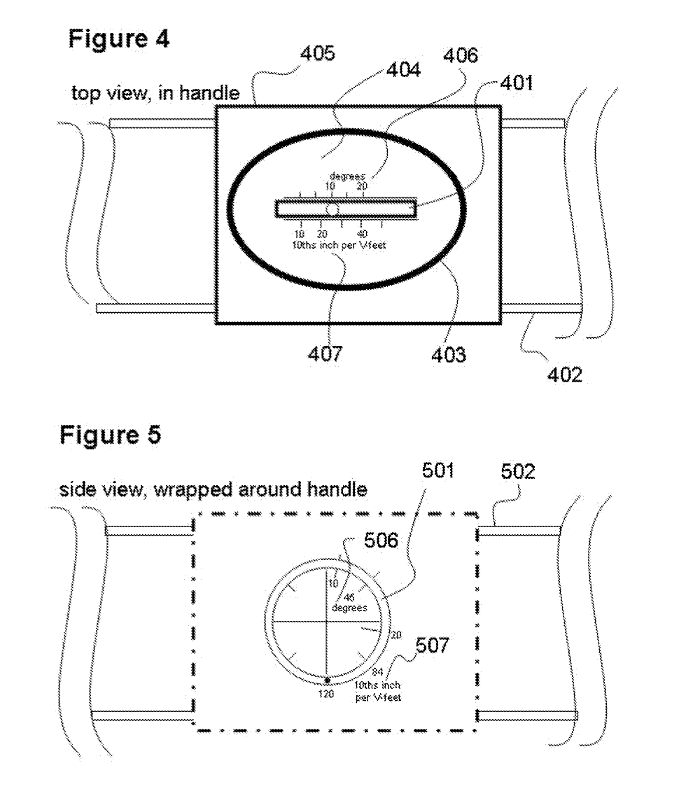

FIG. 4 suggests one of many ways a mechanical inclinometer would be implemented. The figure shows a top view of an embedded inclinometer 401, in a straight segment or handle 402 and viewed through a hole 403 and window 404 facing “up”. A sleeve 405 represents mechanism that can protect the inclinometer mechanism. Note the display scale 407 of the trigonometric transformation associated with the inclinometer display scale 407. The units are in “10ths inch per V-feet”.

FIG. 4 suggests how position of an inclinometer bubble or ball, for example, is an inclination indicator providing an index pointing to the depth per vector length. The trigonometric transformation is similar to that of a circular slide rule and permitting the tool to provide data to measure or estimate depth.

The embodiment of FIG. 4 illustrates embedding directly inside a handle of an object or implement. The inclination angle is indicated by the inclination indicator of a display scale 406 of the inclinometer. The user can also orient the implement until the inclinometer is at the desired inclination, and measure the distance directly using a length measuring system.

A structural element can be a key element when configured to restore the structural integrity of the segment of the handle breached by the modifications required to embed an inclinometer or other hardware. One way to form the structural element uses a conformal sleeve 405 made of high strength material and extending beyond the hole 403. For example, Kevlar has a higher tensile strength per weight than structural steel or aluminum, and these can be used as sleeve material. “Sleeve” and “conformal” are a generic labels used to include rods, clamps and other structural forms that include embedded and/or conformal elements and yet maintain the ergonomics and feel of the original object.

Many tradeoffs can be associated with the key structural element. As a suggested minimum, the “handle” should retain at least 90% of its unmodified strength.

FIG. 4 may also depict an inclinometer, interface, display and calculation system entirely confined to part of an attachment or sleeve 405 that can be used with many types of objects or implements. Here, for example, the display elements 401, 404, as viewed through a protective window 403, could represent a thin, digital alpha-numeric display.

FIG. 5 shows a notional side view of a mechanical inclinometer 501 that is attached to or conformably wrapped around the contour of an object, such as the handle of a shovel 502. Inclination degrees are displayed on a first scale, 506. A second, trigonometric transformation display scale 507 indicates depth per vector length. For example, another set of gradations 307 display 10th's of an inch per vector foot, as “10ths inch per V-feet”. The second scale 507 is made to slide or rotate relative to the inclinometer 506. One can accommodate a desired slope by rotating the second set of gradations 507 so that its zero lies across from the desired inclination angle on the first scale 506. This rotation constitutes a user's operational data input of the desired slope angle to the trigonometric transformation calculation mechanism. The user can also read the depth per vector length directly off the second scale by placing a ruler point of the object on the excavation and a reference point of the object on a reference point on the imaginary reference line. By permitting the user to move the second display scale relative to the first, one permits the user to input the desired slope and to read the output of the desired depth data.

The inclinometer 501 can be embedded or attached and fastened externally to nearly any object, including a ruler, tape measure or excavation tool, and may be attached using permanent, temporary or quick-connect methods such as magnets or VELCRO, with or without a sleeve, and can be mechanical or can be an electronic level system powered by photovoltaic, motion, batteries or other means.

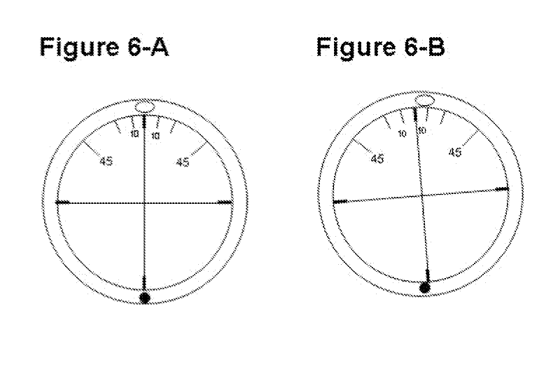

In another embodiment, a mechanical inclinometer such as notionally constructed in the series of FIGS. 6 through 8, can be made to integrate with or dynamically attach directly to a ruler, tape measure or length measuring system, such as to the tape measures commonly used and carried by nearly all construction site workers. One feature distinguishing prior uses and combinations of rulers with inclinometers and levels and this concept is the trigonometric transformation relating angles to distance and distance per vector length.

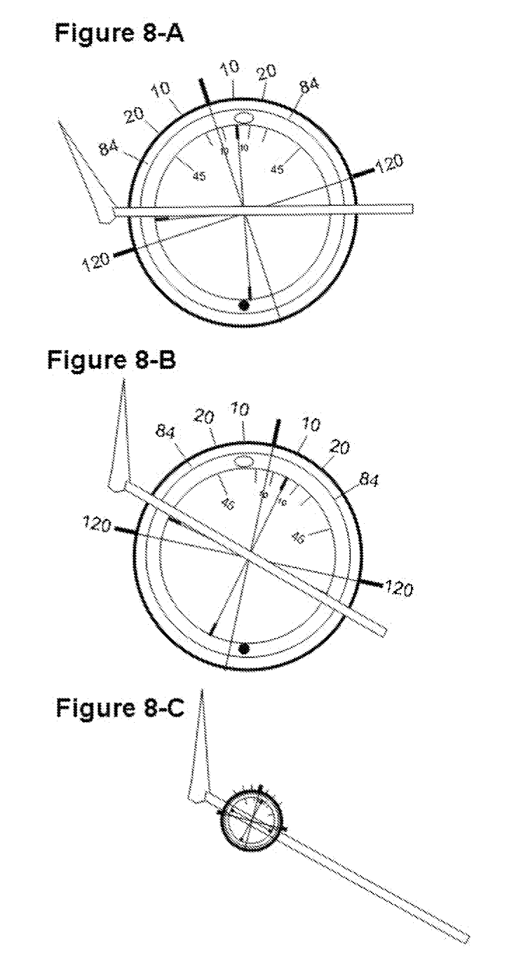

An embodiment used as in FIG. 8-C, FIG. 2 or FIG. 3 would be highly useful when using an inclinometer that may have a low precision, worse than about 0.5 degrees compared to a bubble level but a relatively high angle range, e.g. up to a full 360 degrees. A common inclinometer of this type uses a ball in a tube and is used in off road vehicles, with inclination range typically less than −45 to +45 degrees. One embodiment uses a bubble in a liquid filled tube, which is the generic equivalent to the ball-in-tube inclinometer. Yet another embodiment uses a weighted, circular wheel. All of these have an axis of rotation in common.

FIG. 6-A shows both the ball and bubble version of an inclinometer in a 360 degree inclinometer. The inclinometer can also be implemented as a weighted wheel.

An inclinometer may be embedded, attached, dynamically attached, contacting, or juxtaposed to another object, including to a length measuring device such as a tape measure. When attached to an object, a mechanical inclinometer may be rotated to adjust the inclination indicator to match the true horizontal, as suggested in FIG. 6-B. This compensates for minor misalignments.

Mechanical, ball-in-tube or wheel inclinometers can not only show inclination to an accuracy useful for excavations but can also include an analog display scale of the trigonometric transformation, for example, in units of “depth per vector length” for the “zero degrees” reference line inclination.

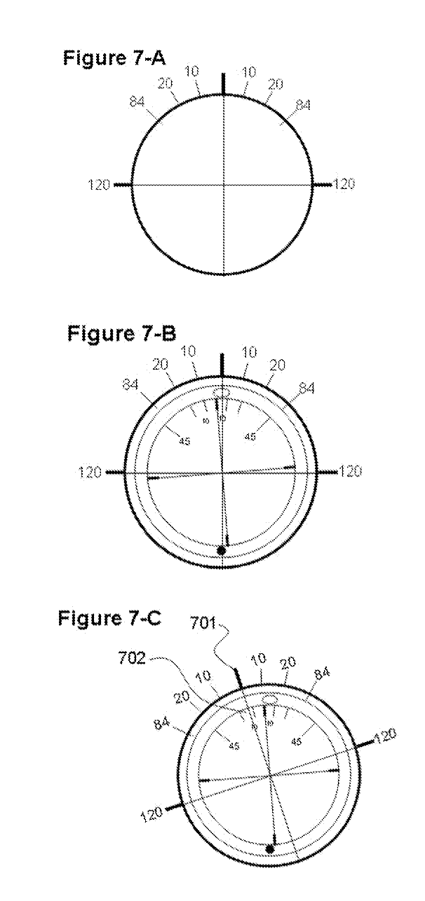

FIG. 7-A shows the trigonometric transformation calculation as another wheel rotated about the same axis as the inclinometer, similar to a circular slide rule. The FIG. 7-A shows such a transformation in units of “tenths of an inch per vector foot”. For example 45 degrees shows about “84” tenths of an inch, which is approximately 84.8528 . . . , which is 120 tenths of an inch×sine (45 degrees).

FIG. 7-B shows the analog display along with the inclinometer display.

A simple method to input operational data can be used with a mechanical inclinometer to indicate the desired slope and then to read out the depth per vector length. FIG. 7-C shows that one need only shift the position of the depth per vector length display scale by an amount equal to the desired slope angle. This shifting constitutes a user input of the desired slope angle to the trigonometric transformation calculation mechanism.

The angle display scale of the inclinometer indicates where to rotate and place the zero of the trigonometric transformation display scale. FIG. 7-C shows the trigonometric transformation display “zero” 701 set to a slope setting 702 of about 12 degrees.

An inclination indicator such as a bubble or ball in tube may then point to the desired inclination of the excavation, as in FIG. 8-A, or a depth per vector length, as in FIG. 8-B. This process is functionally similar to a circular slide rule calculation.

FIG. 8-C indicates a notional placement of the inclinometer and its integrated elements attached anywhere on an implement.

There are many ways to implement the angle and transformation indicators, with easy ways having in common the rotation about a common axis of the angle indicator attached to the inclinometer and the transformation indicator scale. The digital equivalent is obvious from the transformation.

The ball and/or bubble in tube inclinometer can also be implemented to fit a contour, such as the contour of the object so that the assembly can be wrapped around an implement handle or some portion of an object. The “tube” of the ball and tube can be flexible, transparent and attached to a thin, flexible sheet. The sheet can then be used as a sleeve that can be attached to many objects. An attachable inclinometer can in addition be rotated upon attachment by an angle equal to the desired grade or slope, permitting this embodiment to be used for excavating grades. Here we place the inclinometer on one sheet and the trigonometric transformation on another sheet that is centered and rotatable about the same axis as that of the inclinometer. A calculation and display of depth per unit vector length is then indicated at the point indicated by the position of the bubble or ball. When the two or more sheets are flexible, they can be attached in a way that may conform to the contour of the object on which they are attached.

This flexible tube and any associated display markings can provide an exceptionally inexpensive tool. Such a tool to be sufficiently inexpensive as to be expendable.

A table of depth per vector length vs. inclination angle provided with and as part of the tool can also provide the trigonometric transformation without a second, sliding scale.

A person having ordinary skill in the art can readily see that a 360 degree ball-in-tube, bubble-in-tube, or wheel-on-axel inclinometer, along with a trigonometric transformation, sliding scale using the same axis of symmetry (center of rotation) can readily be adapted to fit tape measures, rulers, laser rulers and other length measuring devices. The readout can be configured for any convenient observation angle, such as facing up or facing horizontally.

Electronic devices may be readily programmed to perform the transformation and may include their own inclinometers. Inclination measurements and transformations may also be readily programmed into common hand-held computing/display/interface devices. This permits convenient attachment to wide range of objects, and a readily configured display and user interaction.

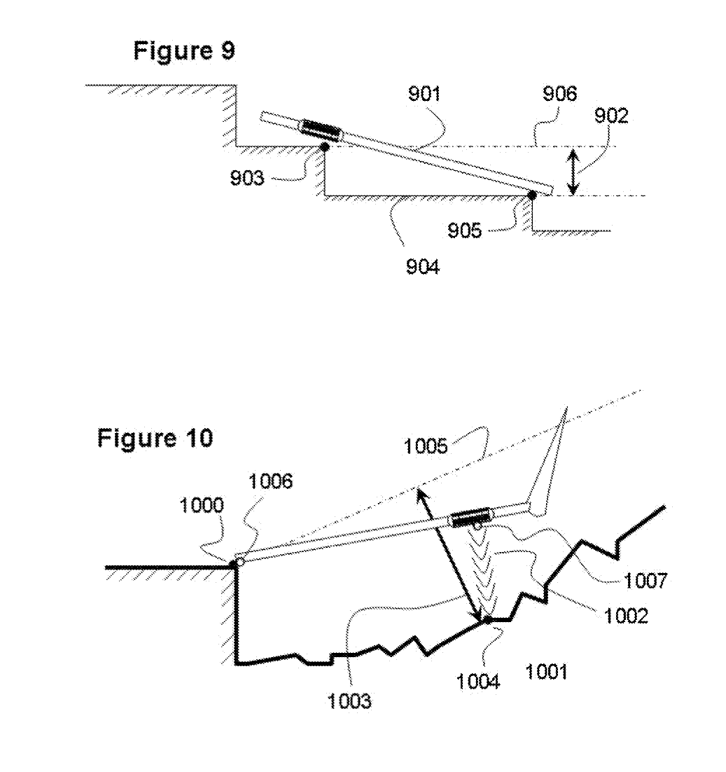

FIG. 9 illustrates using a “depth per vector length” display feature to permit an object 901 to be used as a general tool to measure or estimate the difference in elevation 902 between two points 903, 905 or two elevations 904, 906. This embodiment also shows the inclinometer to be attached to or associated with any object or implement 901 that has accessible points that permit convenient contact with the reference 903 and point of interest 905 on a segment of the object 901.

FIG. 9 may also notionally illustrate a laser ruler or laser pointer substituting for the object 901. For example, the drip of the laser ruler can be co-located with the inclinometer and placed on one level 903 and the laser beam point to the other level 905. Digital readout and computation then renders the elevation depth.

FIG. 10 shows an even more general use with only one point of contact 1000 with the reference line 1005. The embodiment can be used to measure the shortest distance 1003 from a point in space 1004 to an imaginary sloped line 1005. A reference point of the object 1006 is brought into contact with the reference point 1000 on the imaginary reference line 1005. A length measurement system measures the distance directly from a ruler point 1007 of the object to an interest point 1004 or excavation. The implement on which the inclinometer system is attached need only have accessible reference points and ruler points of known location. The points do not need to be on a straight segment as long as their vector locations are known. The points can reside on a highly irregular object. A highly useful tool and tool combination can result from this variation of the same tool or same combination tool. As seen in FIG. 10, this embodiment permits the tool to be held at any angle and still accurately estimate the distance from a point in space to a reference line. The embodiment uses a length measuring system such as a touchless system 1002 or ruler to measure distance. When the object vector 1006, 1007 is known or determined, the precise distance 1003 may be calculated from a trigonometric calculation using the inclination, the measured distance and desired percent grade. The calculation can be performed in many known ways, including using a computer or an analog means such as forms of slide rules.

Embodiments may include many forms of length measuring systems either attached to or provided with the object, such as optical, laser, acoustic, super high radio frequency, and mechanical rulers and devices. Embodiments can be implemented using myriad forms of display, user interface, inclination angle determination system, depth determination mechanism or system, power supply, and integration with the excavation tool's or other objects.

References showing mechanical, electrical and other devices and methods to measure inclination are too numerous to mention. A common example of an embedded inclinometer is the electronic inclination measuring device found in smart phone and digital cameras. These inclinometers are generally compact, rugged, low cost, can measure inclinations over a full 360 degree range, and operate at low power.

Myriad variations of the same tool or same grading tool that estimates distance from a point to a line directly above it, or of the same grading tool measuring depth of excavation to a desired grade become evident to a person having ordinary skill in the art, as demonstrated by the following example features of embodiments.

Features of embodiments may include any number of mechanical inclinometers such as bubble levels, long bubble levels, calibrated bubble levels, levels incorporating analog trigonometric calculations as part of the readout, asymmetrically weighted wheels, pendulums, free floating asymmetrically weighted spheres suspended in liquids and floats attached to wheels. Inclinometers may indicate any angle up to a full rotation, 360 degrees, and may include many forms of display at the same time. Gradations can be marked on the periphery of a wheel. Displays may be entirely electronic.

Display features may indicate a desired representation of the grading information, such as the inclination angle of the handle, the amount of excavation yet to be performed, angle of handle relative to desired slope, the depth of the grade, or other data. Displays may feature alphanumeric, electronic and spoken data in any desired language. Interface features may include means to exchange operational data. Such means include a keypad of the system, or a keypad input communicated to the system from elsewhere using one or more of many communication methods, such as wireless IR, wireless radio, acoustic, magnetic or hardware methods originating in devices with keypads such as cell phones and the like.

An integration feature integrates the object or excavation tool dynamically. An inclinometer and/or its display and/or its interface may be attached to nearly any convenient object or objects, for example, an object with a usefully straight segment and a tape measure. The attaching may include, for example, taping it to nearly any object, using a quick-connect, snap-on, quick-attach fastener such as a VELCRO system, screwing it on, using clamps, quick-connect clamps, magnets, glue, and a myriad number of methods to fasten it.

A dynamic attachment feature permits indicating where the prescribed points reside on an object by deliberate positioning the attachment. The sleeve may also be a dynamically repositionable sliding sleeve that may be manually moved or positioned at desired places along the handle. The point that touches the excavation, a ruler point, can be the non-shovel end of a shovel, or the non-rake end of a rake, or the non-chopper end of a chopper. Ruler points can be measured and/or indicated on the handle.

A feature uses sleeves as forms of integration to give embodiments extra utility. A sleeve placed around or attached to the handle may be used to incorporate all or part of an inclinometer, display, power system, data communication and other devices. Such a sleeve permits integration to many forms of object or tools, items or implements. A sleeve feature may be used to assure or enhance the mechanical integrity of the excavation tool in regions where the handle has been modified. A sleeve including a form-fitting grip may enhance ergonomics.

A myriad of known ways are known to communicate angle and depth information to and from a user and are too numerous to enumerate.

An integration feature includes placing all or part of the system inside a handle. Modern shovel handles for commercial use are typically made of fiberglass for several reasons, including a high strength per unit mass, durability and cost. Often, fiberglass handles consist of hollow tubes or cylinders. The hollow interior provides a convenient location to place embedded systems without degrading handle strength and also provides a significant element of physical and mechanical protection of the systems. The electrically insulating feature of the fiberglass makes the handle almost transparent to electromagnetic communication into and out of the handle, such as magnetic signals, optical signals or radio wave signals. Data transceivers may then be placed on or along the inside and/or the outside of a shaft of the commercial grading tool. Transceivers may also be located anywhere within the range of a wireless transmission of the angle detection system.

It would be advantageous to display depth and inclination data using numbers, sounds, words, mechanical vibrations, colored lines, analog lines of various shapes and lengths determined by the data, or other forms of interface.

It would be advantageous to include an analog depth data feature such as a strip display. An ambient light, electronic display, with optional backlight, may darken the portion of the display that represents the distance excavated and yet to be excavated.

It would be advantageous to exchange data with other devices, for example to mechanical interfaces, keypads, to handheld devices, to computers or cell phones, a boom box or a radio tuned to an unused frequency.

It would be advantageous for the communication means to be any of the known mechanisms, including but not limited to a mechanical, optical, IR, and an electrical connection, an optical fiber, an acoustic signal.

It would be advantageous to use any one or more of the myriad methods to power various systems of the tool. Electronic devices may be energized in whole or in part by photovoltaic systems, by batteries, by wireless charging systems, by incorporating magnetic coils used to couple external AC power to the charging circuits, by fuel cell systems, by plug-in systems, mechanical systems or other methods of providing energy.

It would be advantageous to use the intrinsic motion of an excavation tool during its use to energize mechanical to electrical energy conversion devices.

It would be advantageous to incorporate electronic forms of ruler, such as a laser, RF, optical, ultrasound or acoustic ruler. It would be advantageous to use the electronic forms to define a virtual handle, extending the effective maximum length of a straight segment of a tool, for example, to that provided by the laser ruler.

It would be advantageous to use the hollow interior space of fiberglass handles to provide a space to embed other systems such as energy converters or other devices.

It would be advantageous to take advantage of the hollow interior space of fiberglass handles to enable the mechanical integrity of the handle to be uncompromised by the inclusion of embedded systems.

It would be advantageous to be able to dynamically set the position of or distance between the reference and excavation points contacting the handle of the system. Various means to set this position are evident, for example, by including sensors or interface systems associated with the tool to detect indicated positions

It would be advantageous to use a method to determine the vector length, and especially the position of an arbitrarily designated reference point of the implement or of a tool handle, relative to the point of interest or excavation point. Various means are evident. In one example, acoustic sensors at extremities of the tool can measure the time of arrival of the acoustic pulse generated when the tool touches the reference. A computing system calculates the position of the touching point. In another example, the touching point at the reference and the touching point at the excavation are boundary conditions which set the lowest frequency of the transverse vibration modes of an object, which are directly related to the vector length. Any impulse excites these modes, which are detectable and readily analyzed.

It would be advantageous for an angle determination and display system to receive information to direct how to operate, display or calculate grade depth. Many methods are known to communicate to the system.

We claim:

1. An apparatus, comprising:
an inclinometer capable of measuring an inclination angle of a vector beginning at a reference point on a reference line in space and ending at a point in space directly on, above or below the reference line;
a capability to calculate the results of a trigonometric transformation relating the inclination angle to the ratio given by the shortest distance from the point in space to the reference line divided by a unit of length of the vector, also referred to as “depth per vector length”

2. The apparatus of claim 1, further comprising:
an inclinometer configured to be capable of being integrated with, associated with, embedded in, attached to, dynamically attached to, contacting, or juxtaposed with an object;
an interface capable of inputting operational data;
an interface capable of formatting, outputting and displaying results.

3. The apparatus of claim 1, further comprising:
a form of length measuring system, referred to as a ruler, and capable of being integrated with, associated with, embedded in, attached to, dynamically attached to, contacting, or juxtaposed with an inclinometer.

4. The apparatus of claim 1, further comprising:
an object having at least a first point accessible for direct contact with a reference point on the reference line in space and at least a second point accessible for direct contact with the point in space directly on, above or below the reference line, the two points on the object defining an object vector;
the inclinometer configured to be integrated with, associated with, embedded in, attached to, dynamically attached to, contacting, or juxtaposed to the object; and
the inclinometer configured to report the inclination angle of the object vector.

5. The apparatus of claim 4, further comprising:
a form of length measuring system, referred to as a ruler, configured to be integrated with, associated with, embedded in, attached to, dynamically attached to, contacting, or juxtaposed to the object;
the ruler configured to be able to measure the length of the object vector;
an interface capable of calculating trigonometric transformations as a function of the length and inclination angle the object vector; and
the interface capable of reporting results related to the ratio of the shortest distance of the point in space directly on, above or below the reference line divided by a length proportional to length of the object vector.

6. The apparatus of claim 5, further comprising:
an interface capable of reporting the shortest distance from the point in space directly on, above or below the reference line to the reference line.

7. The apparatus of claim 3, further comprising:
an object having at least a first point accessible for direct contact with a reference point on the reference line in space;
the object having at least a second point of the object accessible to the ruler;
the inclinometer configured to measure the inclination angle of the vector defined by the first and second points of the object;
the object configured so that the vector lies along the reference line;
the ruler configured to measure the distance from the second point of the object to the point in space directly on, above or below the reference line,
wherein the measured distance thereby represents the shortest distance from the point in space to the reference line.

8. The apparatus of claim 3, further comprising:
an object having at least a first point accessible for direct contact with a reference point on the reference line in space;
the object having at least a second point of the object accessible to the ruler;
the inclinometer configured to measure the inclination angle of the vector defined by the first and second points of the object;
a capability for a length measuring system to determine the length of the vector;
the ruler configured to measure the distance from the second point of the object to the point in space directly on, above or below the reference line, and
a capability to perform trigonometric transformations.

9. The apparatus of claim 1, further comprising:
an inclinometer display scale configured to have a circular center of symmetry;
a trigonometric transformation display scale configured to have the same circular center of symmetry as the inclinometer;
the inclinometer scale and trigonometric transformation scale configured with adjacent displays;
the trigonometric transformation display scale configured to be rotatable with respect to the inclinometer scale about the common center of symmetry and configured so that a user may indicate the inclination of the reference line in space by aligning the zero of the transformation display scale with the inclination angle displayed by the inclination display scale; and
the inclinometer capable of being associated with, attached to or integrated with an object.

10. The apparatus of claim 9, further comprising:
a form of length measuring system capable of being associated with, attached to or integrated with the inclinometer.

11. An apparatus, comprising:
an manually powered object associated with an excavation site and having a relatively straight segment;
the straight segment having at least a first point accessible for direct contact with a reference point on a reference line in space;
the straight segment also having at least a second point accessible to a length measuring system, the first and second points defining an object vector;
an inclinometer configured to measure the inclination of the object vector;
a capability to calculate a trigonometric transformation;
an interface of the inclinometer output configured to calculate a trigonometric transformation reporting the ratio of the shortest distance of a point in space directly above or below the reference line divided by a unit of length proportional to length of the object vector.

12. The apparatus of claim 11, further comprising:
the second point is configured to be able to contact a point in space directly on, above or below the reference line;

13. The apparatus of claim 11, further comprising:
a length measuring system configured to measure the distance from the second point to a point in space directly on, above or below the reference line.

14. The apparatus of claim 11, further comprising:
an interface of the inclinometer output configured to display a trigonometric transformation reporting the ratio of the shortest distance of a point in space directly above or below the reference line divided by a unit of length proportional to length of the object vector.

15. An apparatus, comprising:
an manual excavation tool having a relatively straight segment, referred to as a handle;
an inclinometer embedded in the handle;
a window in the handle configured to permit viewing the inclinometer display scale;
a structural element configured to restore structural integrity of the segment of the handle breached by the modifications required to embed the inclinometer to within 90% of the strength of the unmodified handle.

16. The apparatus of claim 15, further comprising:
the structural element includes material with tensile strength per weight equal to or greater than that of aluminum.
